(19) United States
(12) Patent Application Publication
(10) Pub. No.: US 2015/0028058 A1
(43) Pub. Date: Jan. 29, 2015

(54) PUMP-TYPE COSMETIC CONTAINER HAVING STRUCTURE FOR DISCHARGING DIFFERENT KINDS OF CONTENTS AND METHOD FOR MANUFACTURING THE SAME

(71) Applicant: YONWOO Co., Ltd., Incheon (KR)

(72) Inventors: Hak-Chan Kim, Incheon (KR); Shin-Bok Jung, Incheon (KR); Sung-Hwan Kim, Incheon (KR)

(73) Assignee: YONWOO Co., Ltd., Incheon (KR)

(21) Appl. No.: 14/378,469

(22) PCT Filed: Feb. 28, 2013
(86) PCT No.: PCT/KR2013/001615

§ 371 Date: Aug. 13, 2014

(30) Foreign Application Priority Data
Feb. 29, 2012 (KR) 10-2012-0020937

(51) Int. Cl. B05B 11/00; A45D 34/00

(52) U.S. Cl. CPC B05B 11/3001; A45D 34/00; B05B 11/0037
USPC 222/135; 29/428

(57) ABSTRACT

A pump-type cosmetic container having a structure for discharging different kinds of contents and to a manufacturing method of the same, holds two different kinds of contents respectively in the upper and lower sections within a single container body, thus providing a slim cosmetic container, and allows cosmetics that should be used sequentially when applying make-up to be contained in a set, thus providing users with convenience.

### TECHNICAL FIELD

This present invention relates to a pump-type cosmetic container having a structure for discharging different kinds of contents and to a method for manufacturing the same. The pump-type cosmetics container of the present invention may contain different kinds of liquid contents respectively in the upper and the lower sections within a single container body, thus providing a slim cosmetic container and allowing for improved portability. Furthermore, the container and the method for manufacturing the same according to the present invention may enable cosmetics that should be used sequentially when applying make-up to be contained in a set, thus providing users with convenience.

### BACKGROUND ART

Generally, a conventional pump-type cosmetic container has a pumping structure that discharges the contents by pumping the pumping member which is attached to the top of the container body, and a container body that holds contents, a pumping member that is connected to the top of the container body and draws up the contents by making the inside of the container vacuous and pumping the contents out, and a piston that is secured inside the container body and ascends/descends by the movement of the pump.

The above pump-type cosmetic containers can hold various contents in the different container depending on the purpose of the skin care, such as whitening cream and anti-wrinkle cream. Since the different cosmetics are sold in separated containers, users should purchase each of cosmetics that is contained in a separate container according to different purpose. Furthermore they find it inconvenient to carry all the separate containers in their bag, due to their volume.

In addition, when they go out, users should carry a lot of cosmetic containers for skin care. Even though some of cosmetics are supposed to be applied on the face in certain order, such as skin lotion followed by emulsion, they cannot provide themselves with proper skincare when they forget one or two cosmetics by carelessness. In addition, they have to check all of each container whenever they do makeup, which results in inconvenience for the users.

### DISCLOSURE OF INVENTION

### Technical Problem

This present invention is invented to solve the above problems. The object of the present invention are to hold two different contents, the upper and the lower, into one container body, which makes it easy to carry due to the slim cosmetics container, and also enables cosmetics to be contained in a set so that users can apply cosmetics sequentially when they do make-up, and to provide the method for manufacturing the pump-type cosmetics container

### Method to Solve the Problems

To solve the above-mentioned problems, the present invention, a pump-type cosmetic container having structure for discharging different kinds of contents, comprises a container body that is divided into upper and lower sections for holding contents; pistons 1,2 that move in the opposite directions in the middle center of the container body; pumping members 1,2 that are connected into either upper end or lower end, and discharge the contents by pumping; and button parts 1,2, which are attached to the pumping members 1,2 respectively, put pressure into the pumping members 1,2 and discharge the contents through the discharging holes.

In addition, the said container body comprises a securing protrusion that surrounds the inner side of the container body and allows the pistons 1,2 to land on safely.

In addition, the said container body comprises an air hole at the side of the middle, so that air can move in and out.

In addition, the said air hole is penetrated into the area where the said securing protrusion is formed at the side of the container body, and make either of the pistons 1,2 ascends/descends as the contents are being used.

On the other hand, according to the present invention, the manufacturing method of the pump-type cosmetic container having a structure for discharging different kinds of contents includes the manufacturing stage of the container body that has a cylinder with upper and lower ends open, includes a securing protrusion jutted out as surrounding the inner side of the container body, and possesses an air hole that is penetrated in the direction to the said securing protrusion; the stage of inserting the pistons that are inserted into open upper and lower ends; the contents filling stage in which the contents 1,2 are filled respectively through the open upper and lower ends; the stage of combining the pumping members in which the pumping members 1,2 discharge the contents 1,2 by pumping movement in the upper and lower part of the container body; and the stage of combining the button parts in which the button parts 1,2 are combined onto the top of the said pumping members 1,2.

In addition, during the said piston insertion stage, the pistons 1,2 which are inserted into the container body in the opposite directions, landed safely either on one end or on the other end of the securing protrusion, and are placed separately.

### Effects of Invention

As stated above, the pump-type cosmetic container of the present invention may contain different kinds of contents respectively in the upper and lower sections within a single container body, thus providing a slim cosmetics container and allowing for improved portability. Furthermore, the present invention may enable cosmetics that should be used sequentially when applying make-up to be contained in a set, thus providing users with convenience.

### BRIEF DESCRIPTIONS OF DRAWINGS

FIG. 1 is a disassembled perspective view illustrating the discharging structure of a cosmetics container having two kinds of contents according to a preferred embodiment of the present invention.

FIG. 2 is a perspective view illustrating the discharging structure of a cosmetics container having two kinds of contents according to a preferred embodiment of the present invention.

FIG. 3 is a cross sectional view illustrating the discharging structure of a cosmetics container having two kinds of contents according to a preferred embodiment of the present invention.

FIG. 4 is a use state view illustrating the discharging structure of a cosmetics container having two kinds of contents according to a preferred embodiment of the present invention.

FIG. 5 are explanation drawings illustrating the manufacturing stages of the discharging structure of a cosmetics container having two kinds of contents according to a preferred embodiment of the present invention.

### BEST MODES FOR CARRYING OUT THE INVENTION

The followings are explanations of the present invention in detail on reference to floor plans

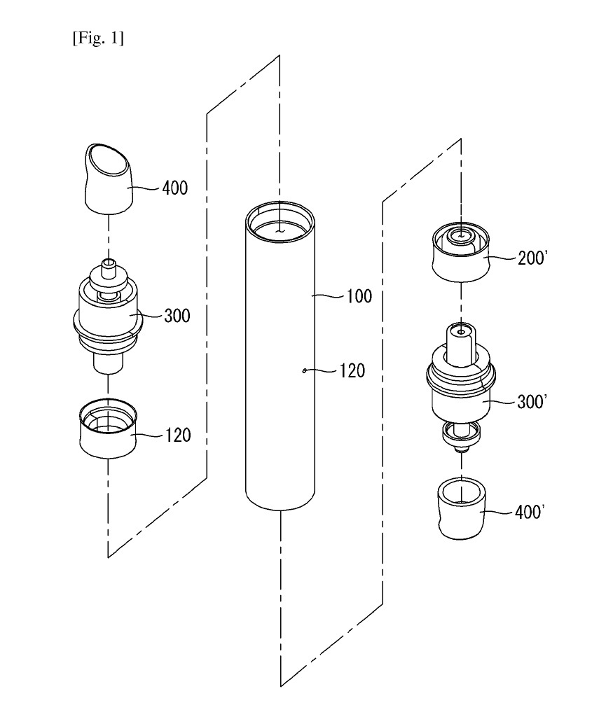

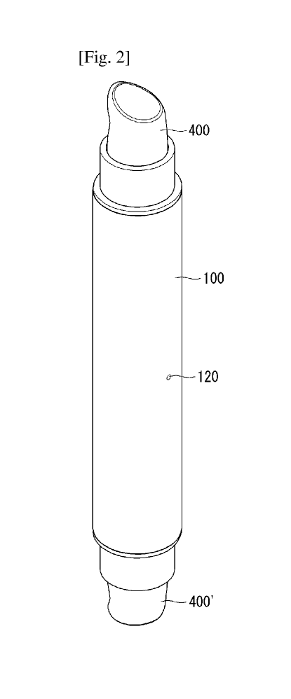

FIG. 1 is a disassembled perspective view illustrating the discharging structure of a cosmetics container having two kinds of contents according to a preferred embodiment of the present invention, and FIG. 2 is a perspective view illustrating the discharging structure of a cosmetics container having two kinds of contents according to a preferred embodiment of the present invention.

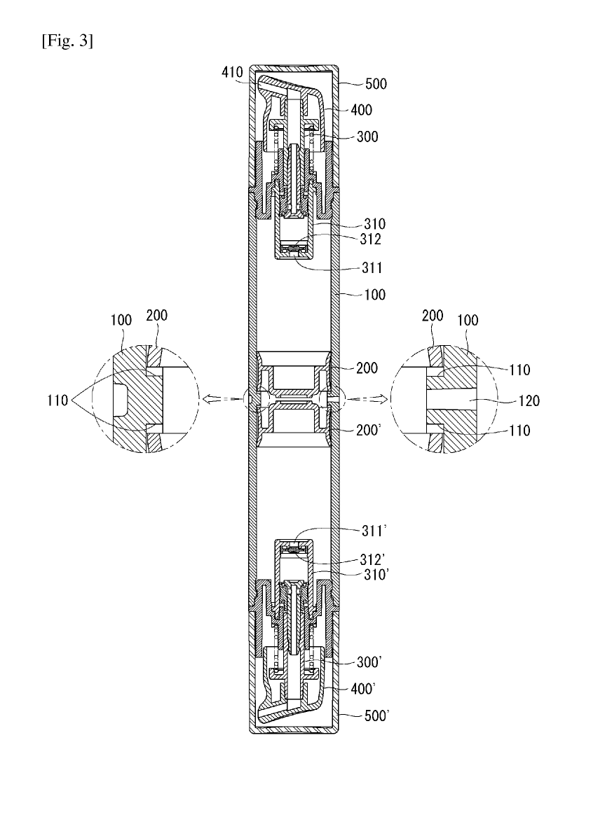

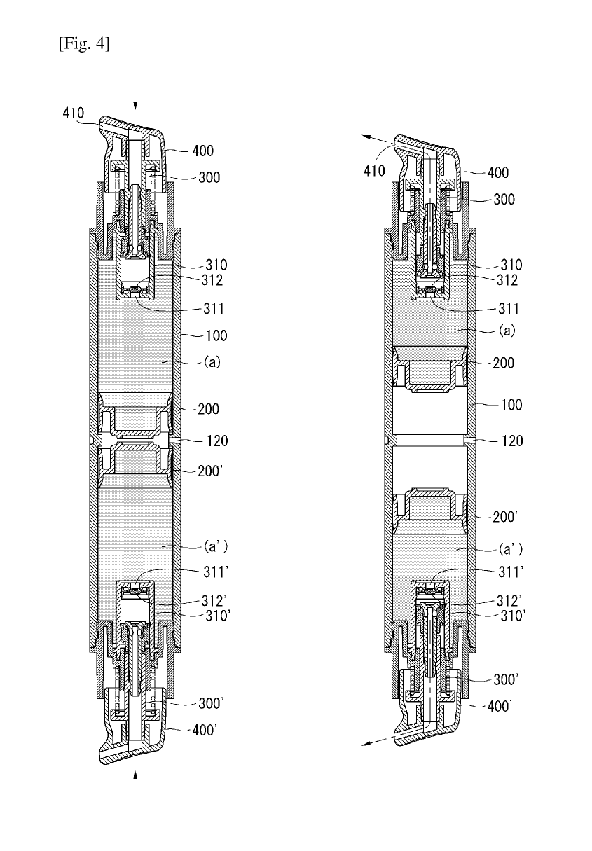

FIG. 3 is a cross sectional view illustrating the discharging structure of a cosmetics container having two kinds of contents according to a preferred embodiment of the present invention, and FIG. 4 is a use state view illustrating the discharging structure of a cosmetics container having two kinds of contents according to a preferred embodiment of the present invention.

On reference to from FIG. 1 to FIG. 4, the discharging structure of a cosmetics container having two kinds of contents according to a preferred embodiment of the present invention comprises the container body 100, the pistons 1,2 200,200′, the pumping members 1,2 300,300′ and the buttonparts 1,2 400, 400′.

The said container body 100 comprise a fixed-length cylinder with the upper and lower ends open, and in the present invention, the said container body 100 has a securing protrusion 110 in the middle of the inner side of the container body 100 so that the two kinds of contents are filled separately into the upper and lower sections.

The said securing protrusion 110 encircle the inner side in the middle part of the container body 100 and protrude, so that the pistons 1,2, 200, 200′ which will be described later, reach on the one base and the other base in the opposite direction from each other; therefore, now the contents 1,2 can be filled into the separated spaces inside of the container body 100.

On the other hand, with the present invention, the air holes 120 are formed at the side of the middle part of the container body 100 for the air passage. The said air holes 120 are penetrated into the area of the said securing protrusion 110 at the side of the said container body 100, and allow the air to flow in through the separated space as the pistons 1,2 are moving up; as a result, as the contents a, a′ are being used, either of the pistons 1,2 200,200′ can ascend and descend.

The said pistons 1,2 200, 200′ ascend and descend inside of the container body 100 as the contents are being used. With the present invention, the said pistons 1,2 200,200′ reach the one end and the other end of the securing protrusion 110 inside the middle part of the container body 100.

The said pistons 1,2 200,200′ separated by the said securing protrusion 110 has some space, and when the contents a,a′ in the container body 100 are being used, either of the pistons 1,2 200,200′ is moved by the air flowing in through the air hole 120.

The said pumping members 1,2 300,300′, which are connected respectively with the upper and the lower part of the container body 100, and discharge the contents 1,2 a,a′ outwards from the container body 100 by pumping, comprise the cylinder 1,2 310,310′ that has the inflow holes 1,2 311,311′ through which the contents flow in from the container body 100; and check valves 1,2 312,312′, which are placed on the top of the inflow holes 1,2 311,311′ inside of the cylinder 1,2 310,310′ and prevent the contents from flowing back. The other structure of the said pumping members 1,2 300,300′ is a universally known technology in the field of the present invention; therefore, detailed explanation is omitted.

The said button parts 1,2 400,400′, which are connected to the upper part of the pumping members 1,2 300, 300′, press the pumping members 1,2 300,300′, making the pumping functions initiated, and form the discharging hole 400, which makes the contents discharged by the action of the pumping members 1,2 300,300′.

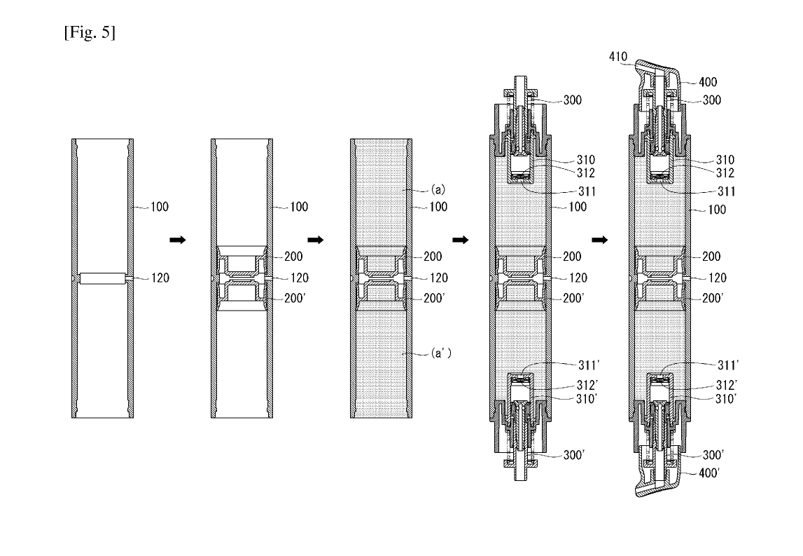

In the followings, referring FIG. 5 there are explanations of the manufacturing stages of the discharging structure of a cosmetics container having two kinds of contents according to a preferred embodiment of the present invention.

FIG. 5 is explanation drawings illustrating the manufacturing stages of the discharging structure of a cosmetics container having two kinds of contents according to a preferred embodiment of the present invention.

According to FIG. 5, the manufacturing method of the discharging structure of a cosmetics container having two kinds of contents is; first a cylinder with both ends open is built, and the securing protrusion 110 is protruded and placed around the inner circle of the middle center, and in the outer middle is formed the container body 100 that has the air hole 120 which is penetrated toward the securing protrusion 110.

Next, the piston 1,2 200,200′ are inserted through the open ends of the said container body. At this time, the said pistons 1,2 200,200′ are inserted in the opposite direction. It is desirable that the pistons should be placed separately, securing respectively on each end of the safe bases 110.

As the above, after the pistons 1,2 200,200′ are inserted into the inside of the container body 100, the said cosmetics contents 1,2 a,a′ are filled through the opening on the top of the said container body 100. After the said cosmetics contents a,a′ are filled, the pumps 1,2 300,300′, which discharge the cosmetics contents 1,2 a,a′ by pumping action of the upper and the lower part of the container body 100, are combined.

Next, after connecting the pumping members 1,2 300,300′ and the container body 100, connect the button parts 1,2 400,400′, which cause the pumping action by pressing the pumping members 1,2 300,300′, on the pumping members 1,2 300,300′.

On the above, the process is displayed as inserting the piston 1,2 200,200′ into the container body 100, and then filling the contents 1,2 a, a′; however, in the practical process, after inserting the piston 1 200 and filling the contents 1 a, the pump 1 300 and the button 1 are connected, so that all process of one side is completed and then go to the other side.

As stated, the present invention comprises the securing protrusion 110 on the inner circle of the middle part of the container body 100, and the piston 1,2 200,200′, which, according to the use of the contents 1,2 a,a′, move to the opposite direction by the air hole 120 on the outer surface of the middle part of the container body 100. This simple structure makes the container slim, so that it is not only convenient to be carried. It can also enable cosmetics to be contained in a set and provide the user with great convenience.

In the figures and the statement, the illustrations of the most preferred embodiment of the present invention are displayed. Some specific terms are used, but these are used for the purpose of accounting for the present invention, not for the limitation of the meaning or the scope of the present invention. Therefore, any ordinary person who are skilled in technical field of the present invention can understand that a variety of modifications and other practical applications are possible. Hence, in the true sense of the technical scope of protection, the present invention should be determined by technical idea of the scopes of the claims as attached.

1-6. (canceled)

7. A pump-type cosmetic container having a structure for discharging different kinds of contents, comprising:
a container body wherein, separated into upper and lower, two kinds of contents are filled;
pistons which are placed in the center of the container, and move in the opposite direction from the center inside of the said container body;
pumping members that are connected with the upper and the lower ends of the said container body, and discharge two kinds of contents from the container body respectively when pressed; and
button parts which are combined to each of the said pumping members, press the pumping members, and form a discharging hole where the contents are discharged.

8. According claim 7, the pump-type cosmetic container having a structure for discharging different kinds of contents, which has a feature wherein the said pumps reach the securing protrusion which encircles the inner middle part of the container body.

9. According to claim 8, the pump-type cosmetic container having a structure for discharging different kinds of contents, which is featured with an air hole that is formed for air passage at the side of the middle part of the said container body.

10. According to claim 9, the pump-type cosmetic container having a structure for discharging different kinds of contents, wherein the said air hole is penetrated into the area of the said securing protrusion at the side of the said container body, and either of the pistons ascends or descends as the contents are being used.

11. The manufacturing method of the pump-type cosmetic container having a structure for discharging different kinds of contents comprises:
the manufacturing stage of the container body, wherein a container body is composed of a circular cylinder whose ends, the upper end and the lower end, are open, a securing protrusion is formed, encircling with protrusion the inner middle part of the container body, and an air hole is penetrated towards the securing protrusion on the middle part of the outer surface;
the insertion stage of the pistons, wherein the pistons are inserted through the upper and the lower ends of the container body;
the filling stage of contents, wherein the contents are filled respectively by the pumps through the open ends into the upper and the lower container body;
the connecting stage of the pumping members, wherein the pumping members, which discharge the contents to the outside by pumping action, are engaged;
the connecting stage of the button parts, wherein the button parts are connected to the tips of the said pumping members.

12. According to claim 7, the manufacturing method of the pump-type cosmetic container having a structure for discharging different kinds of contents has a feature, wherein the pistons that are inserted in the opposite direction during the stage of the above piston insertion stage, are separated and secured on the one end and on the other end of the securing protrusion.
